(19) United States
(12) Patent Application Publication
(10) Pub. No.: US 2022/0338069 A1
(43) Pub. Date: Oct. 20, 2022

(54) METHOD AND DEVICE FOR NOTIFYING MBS STATE

(71) Applicant: Samsung Electronics Co., Ltd., Suwon-si (KR)

(72) Inventors: Hong WANG, Beijing (CN); Lixiang XU, Beijing (CN); Weiwei WANG, Beijing (CN); Yanru Wang, Beijing (CN)

(21) Appl. No.: 17/724,334

(22) Filed: Apr. 19, 2022

(30) Foreign Application Priority Data
Apr. 20, 2021 (CN) 202110425339.6
Nov. 8, 2021 (CN) 202111314534.8

(51) Int. Cl. H04W 36/00; H04W 76/25

(52) U.S. Cl. CPC H04W 36/0007; H04W 36/0016; H04W 76/25

(57) ABSTRACT

The present disclosure provides a method and device for notifying an MBS state.

According to the method of the present disclosure, without increasing signaling, it enables the network to establish a correct transmission mode, improves the utilization rate of network resources, reduces transmission delay, and reduces data loss and delay caused by handover when UE moves. Specifically, the method comprises: receiving, by a mobile management entity (AMF), state information of MBS; and determining, by the AMF, whether to enable a user equipment (UE) to enter an idle mode according to the state information.

### CROSS-REFERENCE TO RELATED APPLICATIONS

This application is based on and claims priority under 35 U.S.C. § 119(a) of a Chinese patent application number 202110425339.6, filed on Apr. 20, 2021, in the China National Intellectual Property Administration and a Chinese patent application number 202111314534.8, filed on Nov. 8, 2021, in the China National Intellectual Property Administration the disclosures of which are incorporated by reference herein in their entirety.

### BACKGROUND

### 1. Field

The application relates to wireless communication technology, and in particular, to a method and a device for notifying a multicast and broadcast service (MBS) state.

### 2. Description of Related Art

5^{th} generation (5G) mobile communication technologies define broad frequency bands such that high transmission rates and new services are possible, and can be implemented not only in “Sub 6GHz” bands such as 3.5GHz, but also in “Above 6GHz” bands referred to as mmWave including 28GHz and 39GHz. In addition, it has been considered to implement 6^{th} generation (6G) mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service-based architecture or service-based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

According to one aspect of the embodiment of the present disclosure, there is provided a method for a multicast and broadcast service (MBS) transmission performed by a target base station, comprising: receiving a handover request including packet data unit (PDU) session information from a source base station; transmitting a path switch request including first indication information related to the MBS to a core network node; and receiving a path switch response including MBS related information from the core network node.

In one example, the PDU session information includes MBS identification (MBS ID) corresponding to the PDU session.

In one example, the first indication information is capability indication information indicating that the base station supports to transmit MBS data in a shared mode, or is the MBS ID. And the MBS related information includes mode indication information indicating a transmission mode of the MBS data on a user plane interface.

In one example, the first indication information is capability indication information indicating that the base station supports to transmit the MBS data in a shared mode, and wherein the MBS related information includes at least one of mode indication information indicating a transmission mode of the MBS data on a user plane interface, MBS ID related to the PDU session information, PDU session ID, MBS quality of service (QoS) flow information, and QoS flow information of the PDU session.

In one example, the MBS ID and PDU session ID are included in the N2 session management SM container or outside the N2 SM container.

In one example, the capability indication information is included in the N2 SM container or is included outside the N2 SM container.

In one example, the handover request also includes an uplink MBS data receiving address.

In one example, the uplink MBS data receiving address is a predetermined value.

According to one aspect of embodiments of the present disclosure, there is provided an MBS transmission method performed by a core network node, comprising: receiving a path switch request including first indication information related to the MBS and PDU session information from a target base station by a first entity of the core network node; and transmitting, by the first entity, a path switch response including MBS related information and a N2 SM container to the target base station.

In one example, the first indication information is capability indication information indicating that the target base station supports to transmit MBS data in a shared mode, or is the MBS ID related to the PDU session. And the MBS related information includes mode indication information indicating a transmission mode of the MBS data on a user plane interface.

In one example, the first indication information is capability indication information indicating that the target base station supports to transmit the MBS data in a shared mode, and wherein the MBS related information includes at least one of mode indication information indicating a transmission mode of the MBS data on a user plane interface, MBS ID related to the PDU session information, PDU session ID, MBS quality of service (QoS) flow information, and QoS flow information of the PDU session.

In one example, the MBS ID and PDU session ID are included in the N2 SM container or outside the N2 SM container.

In one example, the capability indication information is included in the N2 SM container or is included outside the N2 SM container.

In an example, the MBS transmission method according to the embodiment of the present disclosure, further comprises: transmitting, by the first entity, a session update message including first indication information and PDU session information to a second entity of a core network node; receiving, by the first entity, the MBS related information and a N2 SM container generated by the second entity from the second entity.

According to an aspect of embodiments of the present disclosure, there is provided a method for notifying a MBS state, comprising:

receiving, by a mobile management entity (AMF), state information of MBS.

In one example, the AMF decides whether to enable a terminal UE to enter an idle mode according to the state information.

In one example, the AMF obtains the state information of the MBS from an MBS session management entity (MB-SMF).

In one example, the AMF obtains the state information of the MBS from a base station of the access network NG-RAN. In one example, wherein the state information of the MBS includes a certain one of activated, deactivated and updated.

In one example, if the state information of the MBS is activated or updated, the AMF may keep the UE in a connected mode.

In one example, the MB-SMF includes service identification of the MBS and the state information of the MBS outside a session container.

According to an aspect of embodiments of the present disclosure, there is provided a method for notifying a MSB state, comprising:

acquiring state information of MBS; and

transmitting, to an access control and mobile management entity (AMF), the state information of the MBS.

In one example, the method is performed by an MBS session management entity (MB-SMF) or a base station of the next generation radio access network (NG-RAN).

In one example, the state information of the MBS includes one of activated, deactivated and updated.

In one example, if the state information of the MBS is activated or updated, the UE is kept in a connected mode by the AMF.

In one example, if the method is performed by the MB-SMF, service identification of the MBS and the state information of the MBS is included outside a session container.

According to one aspect of embodiments of the present disclosure, there is provided a core network device, comprising: a transceiver configured to transmit and/or receive signals; memory configured to store data, and a processor configured to perform anyone of methods according to various embodiments of the present disclosure.

According to one aspect of embodiments of the present disclosure, there is provided a base station, comprising: a transceiver configured to transmit and/or receive signals; a memory configured to store data, and a processor configured to perform anyone of methods according to various embodiments of the present disclosure.

According to one aspect of embodiments of the present disclosure, there is provided a network device, comprising: a transceiver configured to transmit and/or receive signals; a memory configured to store data, and a processor configured to perform anyone of methods according to various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 illustrates a system architecture of system architecture evolution (SAE);

FIG. 2 illustrates an exemplary system architecture according to various embodiments of the present disclosure;

FIG. 3 illustrates a schematic diagram of an embodiment (hereinafter referred to as the Embodiment 1) according to one aspect of the present disclosure;

FIG. 4 illustrates a schematic diagram of an embodiment (hereinafter referred to as the Embodiment 2) according to one aspect of the present disclosure;

FIG. 5 illustrates a schematic diagram of an embodiment (hereinafter referred to as the Embodiment 3) according to one aspect of the present disclosure;

FIG. 6 illustrates a schematic diagram of an embodiment (hereinafter referred to as the Embodiment 4) according to one aspect of the present disclosure;

FIG. 7 illustrates a simplified block diagram of an example configuration of hardware components of a core network device for performing an MBS transmission method according to various embodiments of the present disclosure;

FIG. 8 illustrates a simplified block diagram of an example configuration of hardware components of a base station for performing an MBS transmission method according to various embodiments of the present disclosure; and

FIG. 9 illustrates a schematic diagram of an activation process according to various embodiments of the present disclosure.

### DETAILED DESCRIPTION

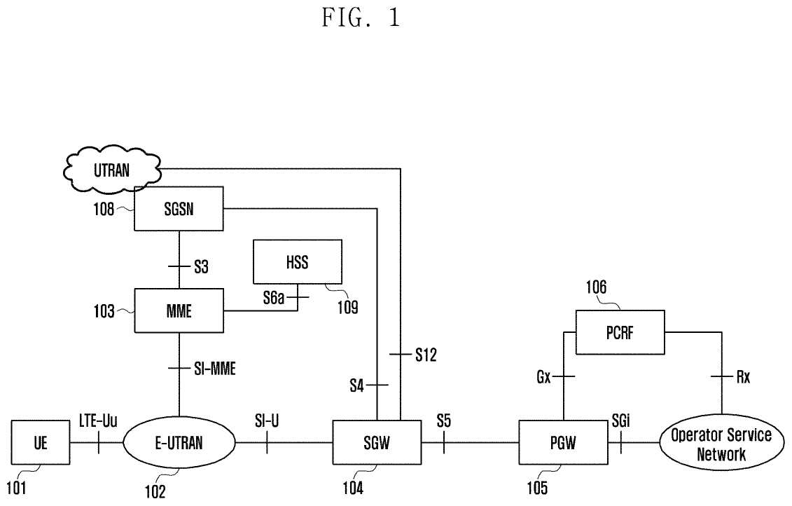

FIGS. 1 to 9 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 illustrates an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104.

A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS)109 is a home subsystem of the UE, and is responsible for protecting user information including a current location of the user equipment, an address of a serving node, user security information, and packet data context of the user equipment, etc.

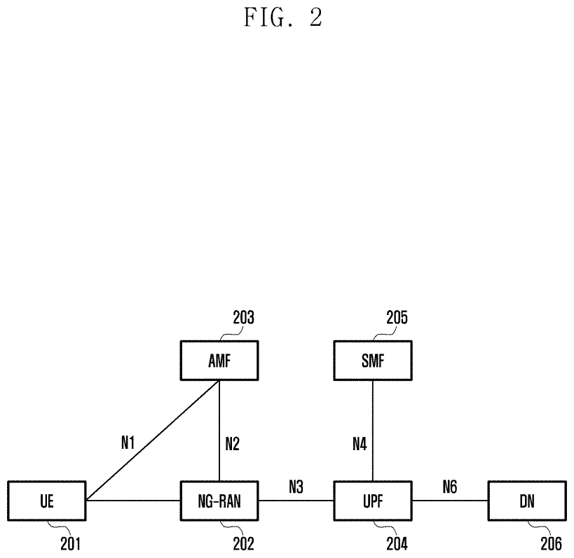

FIG. 2 illustrates an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

The disclosure provides a method and device for multicast transmission. According to the method of the disclosure , without increasing signaling, the method enables the network to establish a correct transmission mode, improves the utilization rate of network resources, reduces transmission delay, and reduces data loss and delay caused by handover when UE moves.

In the following examples, the description is made by taking the 5G system as an example, and the NG-RAN takes gNB as an example. The method is also applicable to corresponding entities of other systems.

In order to effectively utilize the air interface resources, for services with multiple receiving users receiving the same data, the service data is provided to users by means of broadcast and multicast. This service is called multicast and broadcast service, hereinafter referred to as MBS.

In addition to air interface resource sharing, the resources of access network and core network can also be shared. How to enable the core network to decide whether to adopt the sharing mode is one of the problems to be solved by the present disclosure . Another problem is how to decide whether to adopt the sharing mode in the target base station or the target cell when the UE moves. The following description does not distinguish between the base station and the cell, but the description of the cell and the base station can be used interchangeably. The cell is implemented on a base station, and the UE accesses a base station, which actually accesses a cell on the base station.

There are two ways to transmit MBS data on the user plane interface N3 between the core network and the base station: one is to establish a tunnel for each MBS service of each UE at the N3 interface, which is a traditional point-to-point tunnel, and this tunnel is used to transmit MBS data, and this way is hereinafter referred to as N3 unicast mode or N3 unicast tunnel; one is to establish a common user plane between the core network and the base station to transmit MBS data. In this way, multiple users on one base station can receive data of a certain MBS through the same tunnel, which is hereinafter referred to as N3 interface sharing (N3 shared delivery) mode or shared tunnel. The shared tunnel can save the resources of the core network and the access network. However, the problem is that there is a direct interface between the gNB and the AMF, and N3 is the interface between the gNB and the UPF. Then who may decide whether to adopt the shared N3 interface and how to get the information that is helpful to make the decision, are not supported by the current process.

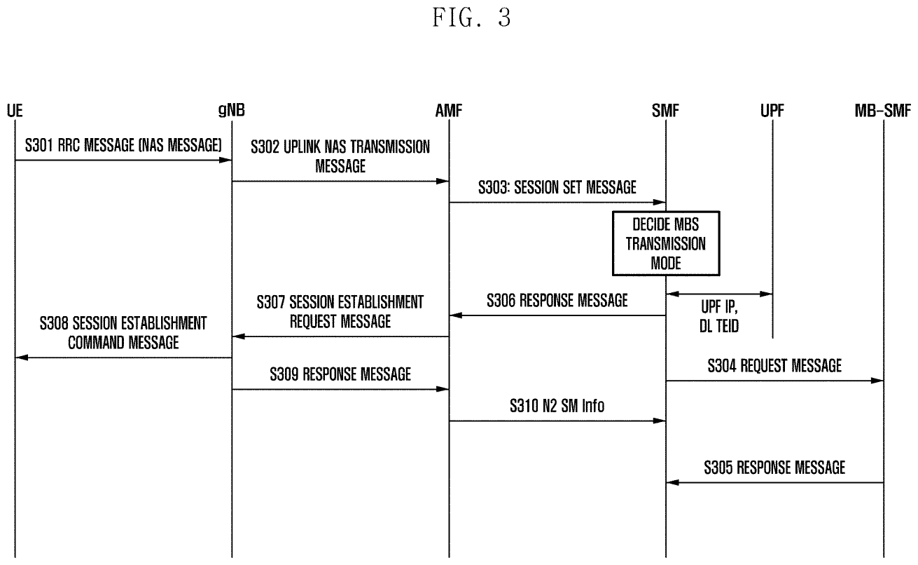

FIG. 3 of the present disclosure describes a method in which the SMF decides whether to use a shared N3 interface for MBS data transmission on the user plane interface N3 between the core network and the base station. With this method, without increasing signaling, the method enables the network to establish a correct transmission mode, improves the utilization rate of network resources, and reduces transmission delay. As shown in FIG. 3 (Embodiment 1). The Embodiment 1 describes the process in which UE joins MBS service and the core network decides whether to use shared resources to transmit MBS data. A detailed description of steps unrelated to the present disclosure is omitted here. The method includes the following steps.

At step 301, the terminal (e.g., UE) transmits a radio connection control (RRC) message carrying a non-access stratum (NAS) message to the base station.

If the UE wants to join a certain MBS service, the UE may transmit a RRC message to carry a NAS message to the network. The NAS message is a non-access stratum message transmitted by UE to the core network, and the NAS message is a message of N1 interface. The base station does not parse the NAS message but forwards the NAS message to the core network. In one embodiment, the name of the message used by the base station to forward the NAS message may be the uplink NAS transmission message. At present, the mechanism is that the node that manages the movement (AMF) and the node that manages the session (SMF) are different nodes, and the NAS transmission message contains the content to be sent to the AMF and the content to be sent to the SMF. The message sent to the SMF is a session-related message, which is placed in a container. The SMF does not parse the container, but transmits the message in the container directly to the SMF.

Specifically, the uplink NAS transmission message contains an identification of the uplink NAS transmission message, indicating that the NAS message is the uplink NAS transmission. In addition, the message also contains the PDU session ID and the type of payload. Herein, the type of payload can be set to N1 session management (N1 SM) message. In addition, the uplink NAS transmission message also contains a payload container. The payload container contains a specific N1 SM message, for example, the N1 SM message is a packet data unit session (PDU session) establishment or modification request message. The PDU session establishment or modification request message contains information of the MBS service, such as the identification of the MBS service, TMGI, which indicates that this session is related to the MBS and the UE wants to join the MBS service. The information of the MBS service here can be parsed by SMF, but cannot be parsed by AMF.

According to a method of the present disclosure , the uplink NAS transmission message also contains the information of the MBS service, such as the identification of the MBS service, TMGI. The information of the MBS service is contained outside the payload container, that is, outside the container of a session management message. The information of the MBS service here can be parsed by AMF.

According to another method of the present disclosure , the uplink RRC message may contain the information of the MBS service, such as an identification of the MBS, indicating in which MBS service the UE wants to join. In this way, the base station can parse the information of the MBS service in the RRC message.

At step 302, the base station transmits a message, such as an uplink NAS transmission message, to the AMF.

Upon receiving the message in step 301, the base station does not parse the NAS message contained in the RRC message, but carries the NAS message in the NAS PDU through the uplink NAS transmission message and forwards the NAS message to the AMF. The uplink NAS transmission message contains identification information of the UE, location information of the UE, and the NAS PDU, which contains the NAS message received by the base station.

According to a method of the present disclosure, the uplink NAS transmission message also indicates MBS capability indication information on whether the base station or cell where the UE is located supports the MBS. It should be understood that in this patent, capability indication information on whether or not to support the MBS, or MBS capability indication information on whether or not to support the MBS, or capability indication information on whether or not to support the MBS service, and similar expressions, refer to whether or not the base station has the capability to transmit the MBS service in the N3 shared delivery mode, and can be used interchangeably hereinafter. The MBS capability indication information here can be parsed by AMF.

Because the base station cannot parse the content contained in the NAS message, if the identification of the MBS is not carried in the RRC message and the base station does not parse the NAS message, the base station does not know whether the NAS message transmitted by the UE is for the purpose of joining in the MBS service. However, only when the NAS message is for the purpose of joining in the MBS service, the base station needs to inform the SMF whether the base station or its cell supports the MBS service. In view of this, in order to solve the problem that the base station cannot determine whether it is necessary to include the capability indication information on whether the base station supports the MBS service in the message in this step, there are the following ways to realize it.

One method is to report the capability indication information to the core network AMF in the process of establishing the NG interface of the base station, for example, through the NG interface establishment request message.

Another method is that the first NG message transmitted to SMF and carrying the NAS message contains the capability indication information on whether the base station or the cell where UE is located supports the MBS service. For example, the NG message may be an initial UE message, or an uplink NAS transmission message, or other message names.

Another method is that all NG messages transmitted to the AMF and carrying the NAS messages contain the capability indication information on whether the base station or the cell where UE is located supports the MBS service. For example, the NG message may be an initial UE message, or an uplink NAS transmission message, or other message names.

At step 303, the AMF transmits a message to the SMF.

The AMF receives the message of step 302, and the AMF saves some information contained in the received NAS PDU. Specifically, the AMF can save information outside the payload container, for example, save the PDU session ID and the identification of the MBS in the received message in the context of the UE. The AMF does not parse the payload container carried in the uplink NAS transmission message, that is, the AMF does not parse the message of the session management in the payload, and the SMF forwards the message of the session management to the SMF.

The message in step 303 contains location information of the UE, and the location information of the UE contains the identification of the cell where the UE is located. The message in step 303 also contains the message of session management, such as PDU session establishment request message.

If the AMF knows the information of the MBS to which the UE may join from the message in step 302, that is, if the AMF receives the information about the MBS service (for example, MBS identification, temporary mobile group identity (TMGI)) that can be parsed by the AMF from the message in step 302, the message transmitted by the AMF to the SMF also contains the MBS capability indication information on whether the base station or cell where the UE is located supports the MBS. The AMF can know whether the base station or its located cell has the ability to support the MBS through pre-configuration, or obtain the MBS capability indication information on whether the base station or its located cell supports the MBS through the method described in step 302. Generally speaking, all cells in a base station have the same ability to support the MBS. However, the present disclosure is not limited to this, and it is also possible to configure different cells on the base station to have different capabilities to support the MBS.

According to the message received in step 303, the SMF knows the MBS service that the UE wants to join according to the MBS identification in the session management message, and the SMF knows whether the cell where the UE is located supports the MBS service according to the MBS capability indication information transmitted by AMF and is about whether the base station supports the MBS. Furthermore, through the service identification, the SMF checks whether there is the relevant information of the MBS service indicated by the service identification in the information saved by itself. If the relevant information of the MBS service has been obtained, it is known that the MBS service has started, and the base station where the UE is located can be known from the location information of the UE. If the UE is the first UE on this base station to join the MBS service, it is up to the SMF to decide which way to transmit the MB S service to the users on this base station, which can be unicast mode or N3 shared delivery mode (i.e., shared mode). The SMF determines the transmission mode, and there are two different ways to realize it.

In one embodiment, if the MBS capability indication information indicates that the base station supports the MBS service, the SMF decides to adopt the N3 shared delivery mode. In this case, the SMF does not need to transmit messages with MB-SMF, nor to select the UPF for UE to transmit unicast, and the SMF can proceed to the following step 306. In one example, the message in step 306 contains an address of the user plane of the uplink data, and the SMF can set the address to a default value or a special value.

In another embodiment,

if the MBS capability indication information indicates that the base station does not support the MBS service, the SMF decides to adopt the unicast mode to provide the MBS service for the UE. In this case, the SMF finds a suitable UPF for the UE, and the SMF transmits a message to the UPF, which at least carries PDU session ID. The SMF obtains from the UPF, the address allocated by the UPF for the user plane of downlink data , for example, obtains the IP address and tunnel endpoint ID (TEID) of the tunnel. The SMF can also get the address allocated by the UPF for the user plane of the uplink data, for example, get the IP address and TEID of the tunnel for receiving the uplink data. After that, the SMF transmits the message to the MB-SMF, that is, the message in step 304, which carries the identification of the MBS, the address of the downlink user plane allocated by the UPF, and the message also contains indication information of the N3 mode. In this case, the indication information can be set to the unicast mode.

In one embodiment, if the MBS capability indication information indicates that the base station supports the MBS service, the SMF decides to adopt the N3 shared delivery mode. In this case, the SMF does not need to transmit messages with MB-SMF, but the SMF needs to select one UPF for the UE. Therefore, the SMF finds a suitable UPF for the UE, and the SMF transmits a message to the UPF, which at least carries PDU session ID. The SMF gets the address allocated by the UPF for the user plane of the uplink data from the UPF, for example, gets the IP address and TEID of the tunnel for receiving the uplink data. The SMF then transmits the message of step 306 to the AMF. The message in step 306 contains the address allocated by the UPF for the user plane of the uplink data.

In one embodiment, if the MBS capability indication information indicates that the base station does not support the MBS service, the SMF decides to adopt the unicast mode to provide the MBS service for the UE. In this case, the SMF finds a suitable UPF for the UE, and the SMF transmits a message to the UPF, the message at least carries PDU session ID. The SMF gets from the UPF, the address of the user plane of the downlink data allocated by the UPF, for example, gets the IP address and TEID of the tunnel. The address of the user plane of the uplink data allocated by the UPF, for example, the IP address and TEID of the tunnel receiving the uplink data, can also be obtained. After that, the SMF transmits a message to the MB-SMF, that is, the message in step 304, which carries the identification of the MBS, the address of the downlink user plane allocated by the UPF, and the message also contains indication information of the N3 mode. In this case, the indication information can be set to the unicast mode.

At step 304, the SMF transmits a message to the MB-SMF.

The message carries the identification of the PDU session, the identification of the MBS, the identification or IP address of the UPF, and the address of the downlink user plane allocated by the UPF (for example, including the IP address and/or TED), and also contains the indication information of the N3 mode, which can be set to the unicast mode.

Upon receiving the message, the MB-SMF can transmit a message to the MB-UPF and forward the identification of the MBS and the address of the downlink user plane allocated by the UPF to the MB-UPF. After receiving the data of the MBS, the MB-UPF can transmit the data of the MBS to the address of the downlink user plane allocated by the UPF. Then the UPF transmits the data to the corresponding base station through the unicast mode, and the base station transmits the MBS data to the UE.

At step 305, the MB-SMF transmits a response message to the SMF.

The session management node (MB-SMF) of the MBS receives the message of step 304. If the message contains the user plane address allocated by the UPF for a certain MBS service, and/or the message carries the indication information of the N3 mode, for example, the N3 mode is set to the unicast, then the MB-SMF transmits the message to the user plane node (MB-UPF) of the MBS. The message transmitted to the MB-UPF carries the PDU session ID, the identification of the MBS and the address of the user plane of the downlink data (this user plane address is allocated by the UPF). The MB-SMF receives such information in step 304 and transmits the information to the MB-UPF. The MB-UPF saves the received information. When the MB-UPF receives data of the MBS corresponding to the identification of the MBS, the MB-UPF forwards the MBS data to the user plane address, so that the UPF can receive the MBS data and transmit the MBS data to the base station in a point-to-point manner.

In addition, the MB-UPF also transmits a response message to the MB-SMF. The signaling step between the MB-SMF and the MB-UPF is omitted here. The MB-SMF transmits a response message to the SMF to confirm the receipt of the information transmitted by the SMF. Because the MBS service only has downlink, the transport layer address of the uplink user plane may not be included here, or the transport layer address of the uplink user plane included in the message may be set to a special value. After receiving this value, the SMF ignores the transport layer address of the uplink user plane. In this way, the signaling interaction between the SMF and the UPF can be reduced.

At step 306, the SMF transmits a message to the AMF.

Upon receiving the message in step 303, the SMF obtains the PDU session ID contained in the SM message and the identification of the MBS, such as TMGI. The SMF checks whether the relevant information of the MBS service has been obtained. If the relevant information of the MBS service has been obtained, it is known that the MBS service has started, and the UE is the first UE to join the MBS service in this base station, then the SMF decides in which way to transmit the MBS service to the users in this base station, otherwise, it means that the SMF has already made a decision before. The decision and behavior of the SMF have been described in step 303.

At step 306, the SMF transmits a message to the AMF, which carries one or more items of the following information:

PDU session ID;

N2 SM Information, which contains the session management information transmitted by the SMF to the base station. The AMF transmits N2 SM Information to the base station. The AMF may not parse the content contained in the N2 SM Information;

The identification of the MBS. Herein, the identification of the MBS can be parsed by the AMF, and the AMF saves the identification of the MBS joined by UE in the context of the UE; or

a session management (N1 SM) container between the UE and the core network, which can contain a NAS message PDU session establishment or modification command message. The AMF and the base station do not parse the content contained in it. The NAS PDU contains PDU session ID, QoS flow Info, associated MBS ID and associated MBS QoS flow.

Herein, the N2 SM Info contains one or more of the following:

session identification (PDU session ID);

quality flow information (QoS flow Info), which contains the identification of QoS flow and the corresponding quality requirements;

identification of the corresponding MBS (associated MBS ID);

quality flow information of corresponding MBS (associated MBS QoS flow Info);

Unicast or shared N3 delivery indication, which is used to indicate the transmission mode of the MBS on the user plane interface N3; or

a transport layer address of the uplink user plane, which is the address allocated by the UPF to receive the uplink data, or a default or special value set by the SMF.

At step 307, the AMF transmits a message to the base station.

The AMF transmits a message to the base station, for example, transmits a PDU session establishment request message to the base station. The message carries one or more items of the following information:

PDU session ID;

NAS PDU; or

N2 SM Info, which is also referred to session establishment request transmission IE. The AMF does not parse such information and transmits the information directly to the base station.

At step 308, the base station transmits a message to the UE.

The base station transmits a RRC message to the UE, to transmit the received NAS message PDU session establishment or modification command message to the UE. The base station saves the information of the received PDU session and the information of the MBS in the context of the UE. If the N2 SM Info indicates that the N3 mode is the unicast, the base station may allocate the user plane of the downlink data for the unicast mode, such as the IP address and TEID of the user plane. If the indication mode is the N3 shared delivery mode, the base station does not need to allocate the downlink user plane for the unicast mode.

At step 309, the base station transmits a message to the AMF.

The base station transmits a response message to the AMF, such as a PDU session resource establishment or modification response message.

The message carries one or more items of the following information:

PDU session ID; or

N2 SM Info, which is also known as session establishment request transmission IE. The AMF does not parse such information and transmits the information directly to the SMF.

The N2 SM Info can specifically contain one or more items of the following information:

QoS flow list;

user plane transport layer information corresponding to the QoS flow, which indicates the user plane address allocated by the base station for the downlink data reception, for example, the user plane transport layer information includes the IP address and TEID. Herein, the user plane of the downlink data is allocated for the unicast tunnel mode, and one PDU session corresponds to one tunnel on the N3;

The identification of the MBS; or

Indication of ignoring the user plane address or/and ignoring the QoS flow list.

At step 310, the AMF transmits a message to the SMF.

The AMF transmits a message to the SMF, which contains the N2 SM information in step 309. If the message contains the indication of ignoring the user plane address or/and ignoring the QoS flow list, the SMF ignores the QoS flow list and the corresponding address contained in the N2 SM information, and does not transmit such information to the UPF, that is, there is no need to establish the user plane of the unicast between the base station and the UPF.

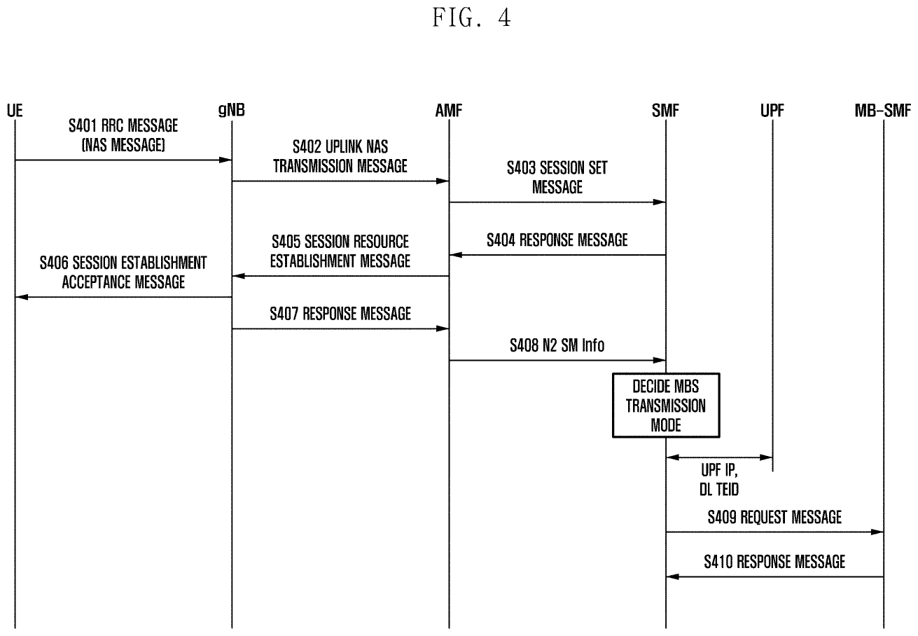

Another method of the MBS establishment process is shown in FIG. 4 (Embodiment 2). The Embodiment 2 describes the process in which the UE joins the MBS service and a point-to-point bearer is established between the core network, the radio access network (RAN) and the UE to transmit multicast and broadcast service data. A detailed description of steps unrelated to the present disclosure is omitted here. Taking the 5G system as an example, the method includes the following steps.

At step 401, the terminal (e.g., UE) transmits a radio connection control message (RRC) carrying a non-access stratum (NAS) message to the base station.

If the UE wants to join a certain MBS service, the UE transmits a RRC message to carry a NAS message to the network. The NAS message is a non-access stratum message transmitted by UE to the core network, which is a message of the N1 interface. The base station does not parse the NAS message but forwards the NAS message to the core network. For example, the name of the message used by the base station to forward the NAS message may be the uplink NAS transmission message. At present, the mechanism is that the node that manages the movement (AMF) and the node that manages the session (SMF) are different nodes, and the NAS transmission message contains the content to be sent to the AMF and the content to be sent to the SMF. The message to be sent to the SMF is a session-related message, which is placed in a container. The AMF does not parse the container, but transmits the message in the container directly to the SMF.

Specifically, the uplink NAS transmission message contains identification of the uplink NAS transmission message, indicating that the NAS message is the uplink NAS transmission. The uplink NAS transmission message also contains PDU session ID and the type of payload. The type of the payload can be set as N1 session management (N1 SM) message. In addition, the uplink NAS transmission message also contains a payload container. The payload container contains a specific N1 SM message, the container is the container of a session management (SM) message, such as a packet data unit session (PDU session) establishment request or modification message. The PDU session establishment or modification request message contains information of the MBS service, such as the identification of the MBS service, TMGI. The information of the MBS service here can be parsed by SMF but cannot be parsed by AMF.

At step 402, the base station transmits a message, such as an uplink NAS transmission message, to the AMF.

Upon receiving the message in step 401, the base station does not parse the NAS message contained in the RRC message but carries the NAS message in the NAS PDU through the uplink NAS transmission message and forwards the NAS message to the AMF. The uplink NAS transmission message contains identification information of the UE, location information of the UE, and the NAS PDU, which contains the NAS message received by the base station.

At step 403, the AMF transmits a message to the SMF.

The AMF receives the message of step 402, and the AMF saves some information contained in the received NAS PDU. For example, the AMF can save the PDU session ID and MBS information therein in the context of the UE. The AMF does not parse the payload container carried in the uplink NAS transmission message, that is, the AMF does not parse the message of the session management in the payload, and the AMF forwards the message of the session management to the SMF.

The message in step 403 contains location information of the UE, and the location information of the UE contains the identification of the cell where the UE is located. The message in step 403 also contains the message of session management, such as PDU session establishment request message.

At step 404, the SMF transmits a message to the AMF.

Upon receiving the message in step 403, the SMF obtains the PDU session ID contained in the SM message and the identification of the MBS, such as TMGI. In addition, the SMF checks whether the relevant information of the MBS service has been obtained. If the relevant information of the MBS service has been obtained to know that the MBS service has started, and the UE is not the first UE to join the MBS service on this base station, which means that SMF has already made a decision on which mode to use to transmit the MBS service.

The SMF transmits a message to the AMF, which carries one or more items of the following information:

PDU session ID;

N2 SM Information, which contains the session management information transmitted by the SMF to the base station. The AMF transmits the N2 SM Information to the base station. The AMF may not parse the content contained in the N2 SM Information;

MBS identification. The identification of the MBS. Herein, the identification of the MBS can be parsed by the AMF, and the AMF saves the identification of the MB S joined by UE in the context of the UE; or

a session management (N1 SM) container between the UE and the core network, which can contain a NAS message PDU session establishment acceptance message. The AMF and the base station do not parse the content contained in it. The NAS PDU contains PDU session ID, QoS flow Info, associated MBS ID and associated MBS QoS flow.

Herein, the N2 SM Info contains one or more items of the following information:

the session identification (PDU session ID);

quality flow information (QoS flow Info), QoS flow Info contains the identification of QoS flow and the corresponding quality requirements;

identification of the corresponding MBS (associated MBS ID);

quality flow information of corresponding MBS (associated MBS QoS flow Info);

a transport layer address of the uplink user plane, which is the address allocated by a UPF for receiving the uplink data, or a default or special value set by the SMF; or

Unicast or shared N3 delivery indication, which is used to indicate the transmission mode of the MBS on the user plane interface N3.

At step 405, the AMF transmits a message to the base station.

The AMF transmits a message to the base station, for example, transmits a PDU session resource establishment or request message to the base station. The message carries the following information:

PDU session ID;

NAS PDU; or

N2 SM Info, which is also known as session establishment request transmission IE. The AMF does not parse such information and transmits the N2 SM Info directly to the base station.

At step 406, the base station transmits a message to the UE.

The base station transmits a RRC message to the UE, to transmit the received NAS message PDU session establishment acceptance message to the UE. The base station saves the received information of the PDU session and information of MBS in the context of the UE. If the N2 SM Info indicates that the mode of the N3 tunnel is the unicast, the base station may allocate the user plane of the downlink data for the N3 unicast tunnel, such as the IP address and TEID of the user plane. If the indication mode is the N3 shared delivery mode, the base station does not need to allocate the downlink user plane for the unicast mode.

At step 407, the base station transmits a message to the AMF.

The base station transmits a response message to the AMF, such as a PDU session resource establishment or modification response message.

The message carries the following information:

PDU session ID; and

N2 SM Info, which is also known as session establishment or modification request transmission IE. The AMF does not parse such information and transmits the information directly to the base station.

The N2 SM Info specifically contains one or more items of the following information:

QoS flow list;

User plane transport layer information corresponding to the QoS flow, a user plane address allocated by the base station for the downlink data reception, for example, the user plane transport layer information includes the IP address and TEID. Herein, the user plane of the downlink data is allocated for the unicast mode, and one PDU session corresponds to one tunnel on the N3;

identification of the MBS;

indication information on whether the base station or its located cell supports to transmit the MB S service in the N3 shared delivery mode. Regarding the ability on whether the base station or cell supports MBS, according to another method of the present disclosure , in this step, the base station informs the SMF whether the base station or cell where the UE is located supports MBS. If the SMF decides to adopt the N3 shared delivery mode, the SMF may ignore the user plane address allocated by the base station for the downlink data reception; or

Indication of ignoring the user plane address or/and ignoring the QoS flow list.

At step 408, the AMF transmits a message to the SMF.

The AMF transmits a message to the SMF, which contains the N2 SM information in step 407. If the message contains the indication of ignoring the user plane address or/and ignoring the QoS flow list, or contains the indication information indicating that the base station can transmit the MBS service in the N3 shared delivery mode, the SMF ignores the QoS flow list and the corresponding address contained in the N2 SM information, and does not transmit such information to the UPF, that is, there is no need to establish the user plane of the unicast between the base station and the UPF.

At step 409, the SMF transmits a message to the MB-SMF.

According to the message received in step 408, the SMF knows the MBS service that the UE is going to join, and the SMF knows whether the cell where the UE is located supports the MBS service, and the SMF checks whether the relevant information of the MBS service has been obtained. If the relevant information of the MBS service has been obtained, to know that the MBS service has started, and the UE is the first UE to join the MBS service in this base station, then the SMF decides in which way to transmit the MBS service to the users in this base station.

If the base station does not support the MBS service, the SMF decides to adopt the unicast mode to provide the MBS service for the UE. Therefore, the SMF finds a suitable UPF for the UE, and the SMF transmits a message to the UPF, which at least carries PDU session ID. Therefore, the SMF gets the address of the user plane of the downlink data and/or the uplink data allocated by the UPF from the UPF, for example, gets the IP address and TEID of the tunnel for the downlink data and/or the uplink data. This step is similar to the current step and may be omitted here. Thereafter, the SMF transmits a message to the MB-SMF, which carries the PDU session identification, the identification of the MBS, the identification of the UPF, and the address of the user plane allocated by the UPF for the downlink data and/or the uplink data. In an example, the message transmitted by the SMF to the MB-SMF may also contain the indication information of the N3 mode, which may be set to the unicast mode.

At step 410, the MB-SMF transmits a response message to the SMF.

The session management node (MB-SMF) of the MBS receives the message of step 409. If the message contains the user plane address allocated by the UPF for a certain MBS service, and/or the message carries the indication information of the N3 mode, and the mode is set to the unicast, then the MB-SMF transmits a message to the user plane node (MB-UPF) of the MBS. The message carries the PDU session identification, the identification of the MBS, the identification of the UPF and the address of the user plane of the downlink data, user plane address is allocated by the UPF and the information thereof is received and is transmitted to the MB-UPF by the MB-SMF in step 409. The M-UPF saves the received information.

When the MB-UPF receives data of the MBS, the MB-UPF forwards the MBS data to the user plane address, so that the UPF can receive the MBS and transmit the MBS to the base station in a point-to-point manner. The MB-UPF transmits a response message to the MB-SMF. The step between the MB-SMF and the MB-UPF is omitted here. The MB-SMF transmits a message to the SMF to confirm the receipt of the information transmitted by the SMF. Because the MBS service only has downlink, the transport layer address of the uplink user plane may not be included here, or the transport layer address of the uplink user plane included in the message sets to a special value. After receiving this value, the SMF ignores the transport layer address of the uplink user plane, thereby reducing the signaling interaction between the SMF and the UPF.

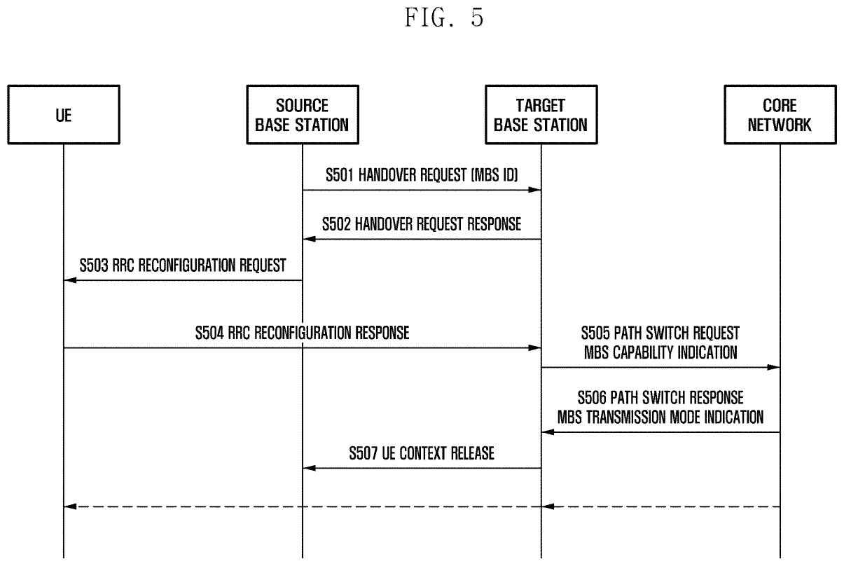

If the UE hands over from a base station that transmits the MBS service in the N3 shared delivery mode, to a target base station, according to the method shown in FIG. 5, it can be ensured that the MBS service can continue being transmitted in the target base station when the UE hands over, thereby reducing the time of service interruption, reducing data loss and ensuring the continuous transmission of the service. FIG. 5 illustrates a schematic diagram of the process of Xn handover by the UE provided in the embodiment 3. This embodiment takes a 5G base station as an example. If it is used in other systems, the names of the corresponding interfaces and messages may be changed accordingly. The UE receives the MBS service through the N3 shared delivery mode at the source base station. If the target base station does not support the MBS service, the target base station needs to use the unicast tunnel to receive the MBS service. The method according to the embodiment of the present disclosure is shown in FIG. 5 and includes the following steps:

At step 501, a source base station transmits a handover request message to a target base station.

The source base station decides to hand over the UE to the target base station according to the measurement result of the UE. The handover request message contains the identification of the target cell and the list of ongoing PDU sessions of the UE. If a certain PDU session is related to the MBS, the handover request message also contains the identification of the MBS, the quality requirements of the MBS and other information. The information of the PDU session related to the MBS includes the receiving address for the uplink data, such as IP address and TEID, which is allocated by the user plane node UPF of the core network, or a special value allocated by the SMF. Because the MBS has no uplink data, in order to reduce the signaling interaction between the SMF and the UPF, the SMF can generate a special value, which is included in the N2 container transmitted by the SMF to the base station. In the aforementioned embodiments, the process between the SMF and the base station was described. Or the source base station can set the uplink data receiving address to a special value by itself, such as setting the UL TEID to a predetermined special value.

If the source base station does not know whether the target base station supports the MBS service, the handover request message includes the identification of PDU session, the identification of corresponding MBS and the quality requirements of the MBS. If the target base station does not support the N3 delivery mode of the MBS, the target base station thinks that the session related to the MBS is a normal PDU session, and the target base station ignores the MBS information contained in the handover request message.

If the source base station knows whether the target base station supports to transmit the MBS service in the N3 shared delivery mode, for example, the source base station may know whether the target base station supports the MBS service by information exchange between base stations on whether MBS is supported or not in the process of Xn establishment request, or through whether the base station or cell supports the MBS service broadcasted in the broadcast message and transmitting the information on whether the target base station/cell supports the MBS service to the source base station through the measurement report of the UE. If the target base station does not support the MBS service, the source base station may not include the information of the MBS service in the handover request message.

At step 502, the target base station transmits a handover response message to the source base station.

If the target base station does not support to transmit the MBS service in the N3 shared delivery mode, the target base station ignores the MBS information contained in the message and treats the PDU session as a normal session. The target base station transmits a handover response message to the source base station. The message carries the identification of the UE on the Xn interface, the bearer information or the PDU session information accepted at the target base station, and the handover command message to be transmitted to the UE.

If the target base station supports to transmit the MBS service in the N3 shared delivery mode, the target base station can know from the handover request message that a certain PDU session is a session related to the MBS, and the target base station saves the information of the PDU session in the context of the UE. If the target base station is transmitting the MBS service in the N3 shared delivery mode, the base station may not allocate resources for this PDU session, for example, it is not necessary to allocate resources on the RAN side for this session, and it is not necessary to allocate a N3 unicast tunnel for this session.

If the target base station is a split base station, the CU-CP of the target base station transmits the UE bearer establishment request message to the CU-UP, which may not contain the information of the PDU session, because the PDU session is related to the MBS, and the data of the MBS is already being transmitted in the target base station in the N3 shared delivery mode; or the UE bearer establishment request message may contain the information of the session, but at the same time, the UE bearer establishment request message contains indication information for informing the CU-UP that it is not necessary to establish a user plane for the session, for example, carrying indication information of the N3 shared delivery mode or other indication information.

After receiving the indication information, the CU-UP does not need to allocate the protocol stack on the RAN side for this session, and does not need to allocate the receiving address of the downlink user plane for this session, because the data of the MBS is already being transmitted in the target base station in the N3 shared delivery mode, and it is not necessary to re-allocate the receiving address of the downlink user plane for the UE to receive the data from the core network. Or by including the PDU session identification and related identification of the MBS in the message, the CU-UP can find the currently allocated N3 shared tunnel through the identification of the MBS in the message. If it is not found, it means that the UE is the first UE on this CU-UP to join the MBS service.

The CU-UP allocates the downlink TED of the N3 shared tunnel for the MBS and transmits the downlink TED of this N3 shared tunnel to the CU-CP in the UE bearer establishment response message. Thereafter, the target CU-CP can transmit the message of step 505 to the AMF of the core network, carrying the MBS identification and the address of the downlink user plane, such as the IP of the CU-UP and the downlink TED of the N3 shared tunnel. In this way, the CU-UP can join the distribution tree of the MBS, and then the core network of the MBS may transmit the data to the CU-UP.

At step 503, the source base station transmits a handover command to the UE.

The source base station transmits the handover command transmitted by the target base station to the UE.

At step 504, the UE synchronizes with the target cell and transmits a handover complete message to the target base station.

At step 505, the target base station transmits a path switch request message to the core network AMF.

If the target base station does not support to transmit the MBS service in the N3 shared delivery mode, the path switch request message contains the location information of the UE and the PDU session lists to be handed over to the target base station, and the location information of the UE contains the unique identification of the cell where the UE is located and the routing area identification where the UE is located. The specific information of the PDU session handed over to the target base station is contained in the N2 SM container, which contains the address of the user plane and the information of the QoS flow.

If the target base station supports to transmit the MBS service in the N3 shared delivery mode, in addition to the above information, the N2 SM container may also contain the indication information that the base station or cell where the UE is located supports the MBS service, which may be contained in or outside the N2 SM container.

Or if the target base station supports to transmit the MBS service in the N3 shared delivery mode, besides the above information, the N2 SM container may also contain the identification of the MBS related to the PDU session. Through the identification, the SMF knows that the base station supports the MBS service and does not need to contact the UPF to allocate the resources of the user plane for the PDU session of the UE.

The core network AMF receives the path switch request message, and the AMF transmits a session update message to the SMF, which contains the content contained in the N2 SM container, the location information of the UE, the indication information that the base station or cell where the UE is located supports the MBS service, or the identification of the MBS. The SMF receives the information and saves the information in the context of the UE. The SMF generates the N2 SM container, which is transmitted to the base station through the message in step 506 below.

At step 506, the core network transmits a path switch response message to the target base station.

The path switch response message contains the identification of the UE in the NG interface, the bearer information of successful handover or the identification of the PDU session, the N2 SM container, which contains the content of the SMF configuration and is transparent to the AMF, and also contains the information of the user plane allocated by the UPF and the QoS information. The SMF can also transmit the mode of the N3 decided by the SMF to the base station via the AMF. That is, the container contains the indication information of the mode of the MBS on the N3, and the mode can be set to the N3 shared delivery or the unicast mode.

At step 507, the target base station transmits the UE context release to the source base station, and the source base station releases the UE context.

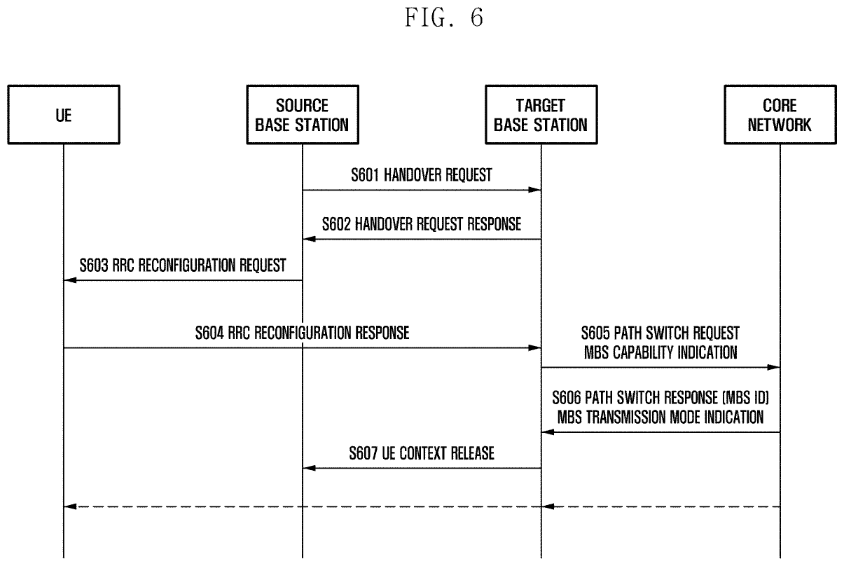

The UE hands over from a base station that does not use the N3 shared delivery mode to a base station that uses the N3 shared delivery mode to transmit the MBS service. At this time, it means that the UE switches from the unicast mode to the N3 shared delivery mode. FIG. 6 is a schematic diagram of the process of Xn handover by the UE provided by an embodiment of the present disclosure. This embodiment takes a 5G base station as an example. If it is used in other systems, the names of the corresponding interfaces and messages may be changed accordingly. The UE receives the MBS service in the unicast mode at the source base station, and the target base station can support the MBS service and transmit the MBS service in the N3 shared delivery mode. As shown in FIG. 6:

At step 601, a source base station transmits a handover request message to a target base station.

The source base station decides to hand over the UE to the target base station according to the measurement result of the UE. The handover request message contains the identification of the target cell and the list of ongoing PDU sessions of the UE. A certain PDU session is related to the MBS, but if the source base station does not support to transmit the MBS service in the N3 shared delivery mode, the source base station cannot parse the content related to the MBS, so the handover request message does not contain the information related to the MBS. The PDU session information in the message contains a UL TEID, which is the uplink data receiving address allocated by the UPF, or a special value set by the SMF or the base station.

When the target base station receives the handover request, if the target base station supports to transmit the MBS service in the N3 shared delivery mode, but because the handover request message does not contain the information related to the MBS, the target base station cannot identify whether a certain PDU session is related to the MBS or not, and may treat the PDU session actually related to the MBS as a normal PDU session. If the target base station accepts the session, the target base station allocates resources for the session.

At step 602, the target base station transmits a handover response message to the source base station.

The target base station transmits a handover response message to the source base station. The message carries the identification of the UE on the Xn interface, the bearer information or the PDU session information accepted at the target base station, and the handover command message to be transmitted to the UE.

At step 603, the source base station transmits a handover command to the UE.

The source base station transmits the handover command transmitted by the target base station to the UE.

At step 604, the UE synchronizes with the target cell and transmits a handover complete message to the target base station.

At step 605, the target base station transmits a path switch request message to the core network SMF.

The path switch request message contains the location information of the UE and the PDU session lists to be handed over to the target base station, and the location information of the UE contains the unique identification of the cell where the UE is located and the routing area identification where the UE is located. The specific information of the PDU session handed over to the target base station is contained in the N2 SM container, and the N2 SM container also contains the address of the user plane allocated by the base station for this session, which is used to receive the downlink data, such as IP address and TEID. The N2 SM container may also contain the information of the QoS flow. In addition to the above information, the N2 SM may also contain the indication information that the base station or cell where the UE is located supports to transmit the MBS service in the N3 shared delivery, which may be contained in or outside the N2 SM container.

The AMF of the core network receives the path switch request message, and the SMF transmits a session update message to the SMF, which contains the content contained in the N2 SM container, the location information of the UE, and the indication information on whether the base station or cell where the UE is located supports the transmission of MBS service in the N3 shared delivery mode. The SMF receives the information and saves the information in the context of the UE. Through the context of the UE, the SMF knows that the PDU session is a session related to the MBS. From the message in this step, the SMF knows that the base station supports to transmit the MBS service in the N3 shared delivery mode, and the SMF does not need to allocate the UPF for this session.

The SMF generates an N2 SM container, which is transmitted to the base station via the AMF in step 606. The N2 SM container is transparent to the AMF. The container contains the identification of the PDU session, the identification of the MBS, the information of the MBS QoS flow and the information of the QoS flow of the session. The SMF can also transmit the tunnel mode on the N3 decided by the SMF to the base station via the AMF, that is, the container contains the indication information of the mode of the MBS on the N3, and the mode can be set to the N3 shared delivery or the unicast mode.

At step 606, the core network transmits a path switch response message to the target base station.

The path switch response message contains the identification of the UE in the NG interface, the bearer information of successful handover or the identification of the PDU session, and the N2 SM container. The N2 SM container contains the content set by the SMF and is transparent to the AMF. The container contains the identification of the PDU session, the identification of the MBS, the information of the MBS QoS flow, the information of the QoS flow of the session, and the mode indication information of the tunnel on N3.

Or if the AMF saves the information of the PDU session and the MBS, the AMF transmits a path switch response, also the identification of the PDU session and the MBS can be included outside the N2 SM container.

After the base station receives the message, if the message contains the identification of the MBS and the base station also supports to transmit the MBS service in the N3 shared delivery mode, if the base station has established the MBS service, the base station can use the established N3 shared delivery to provide the MBS data for the UE. If the UE is the first UE on the base station to receive the MBS service, the base station allocates the downlink TEID of the N3 shared tunnel for the MBS, and then the base station can transmit a message to the AMF of the core network, which carries the identification of the MBS and the address of the downlink user plane, such as the IP of the base station and the downlink TEID of the N3 shared tunnel. In this way, the base station may join the distribution tree of the MBS, and then the core network of the MBS may transmit the data to the base station.

At step 607, the target base station transmits the UE context release to the source base station, and the source base station releases the UE context.

According to the multicast transmission method of the present disclosure, the extra overhead of multicast data transmission can be avoided or reduced, the utilization efficiency of access network resources and/or air interface resources can be improved, transmission delay can be reduced, the data loss can be reduced and the delay caused by the transmission mode conversion can be reduced when the multicast transmission mode is switched.

According to the multicast transmission method of the present disclosure, without increasing signaling, the method enables the network to establish a correct transmission mode, improves the utilization rate of network resources, reduces transmission delay, and reduces data loss and delay caused by handover when UE moves.

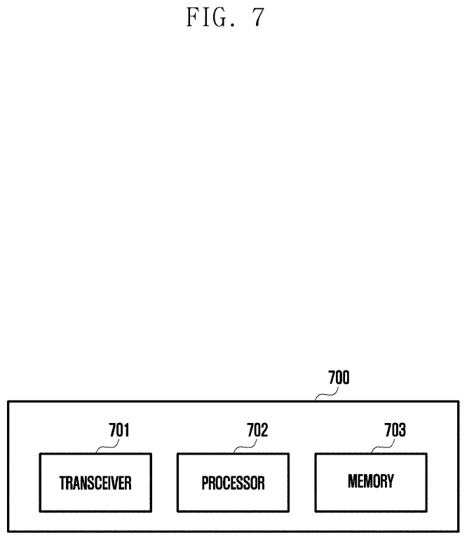

FIG. 7 illustrates a simplified block diagram of an example configuration of hardware components of a core network device 700 for performing an MBS transmission method according to various embodiments of the present disclosure; The device may implement the MBS transmission method or the method for notifying a MBS state according to various embodiments of the present disclosure.

The device 700 can be implemented in any device that can perform the relevant steps in the MBS transmission method or the method for notifying a MBS state according to the present disclosure. As a non-limiting example, the device 700 can be implemented in the AMF or the SMF of the core network, for example, or in any similar device.

As shown in FIG. 7, the device 700 includes a transceiver 701, a processor 702 and a memory 703.

The transceiver 701 is configured to receive and/or transmit signals.

The processor 702 is operatively connected to the transceiver 701 and the memory 703. The processor 702 can be implemented as one or more processors and is used to control the operations of one or more aspects of the MBS transmission method or the method for notifying an MBS state described according to various embodiments of the present disclosure.

The memory 703 is configured to store data. The memory 703 may include a non-transitory memory for storing operations and/or code instructions executable by the processor 702. The memory 703 may include processor readable non-transitory instructions that, when executed, cause the processor 702 to implement the steps of the MBS transmission method according to various embodiments of the present disclosure. The memory 703 may also include random access memory or buffer(s) to store intermediate processing data from various functions performed by the processor 802.

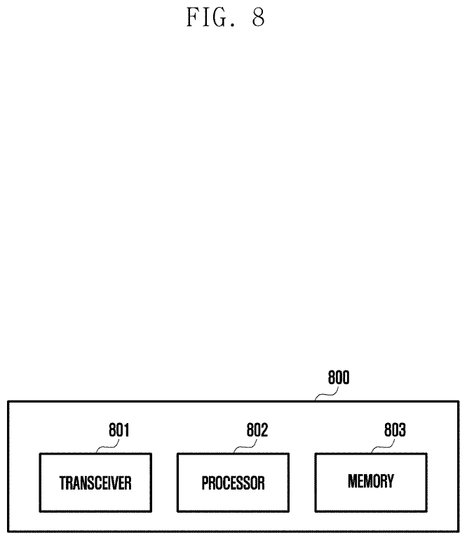

FIG. 8 illustrates a simplified block diagram of an example configuration of hardware components of base station (or a network device) 800 for performing an MBS transmission method according to various embodiments of the present disclosure. The base station (or the network device) may implement the MBS transmission method or the method for notifying an MBS state according to various embodiments of the present disclosure.

The base station (or the network device) 800 can be implemented in any device that can perform relevant steps in the MBS transmission method according to the present disclosure. As a non-limiting example, the base station 800 can be implemented in a base station, a CU-CP or a CU-UP in a 5G access network, for example, or in any similar device.

As shown in FIG. 8, the base station (or the network device) 800 includes a transceiver 801, a processor 802 and a memory 803.

The transceiver 801 is configured to receive and/or transmit signals.

The processor 802 is operatively connected to the transceiver 801 and the memory 803. The processor 802 can be implemented as one or more processors and is used to control the operations of one or more aspects of the MBS transmission method or the method for notifying an MBS state described according to various embodiments of the present disclosure.

The memory 803 is configured to store data. The memory 803 may include a non-transitory memory for storing operations and/or code instructions executable by the processor 802. The memory 803 may include processor readable non-transitory instructions that, when executed, cause the processor 802 to implement the steps of the MBS transmission method or the method for notifying an MBS state according to various embodiments of the present disclosure. The memory 803 may also include random access memory or buffer(s) to store intermediate processing data from various functions performed by the processor 802.

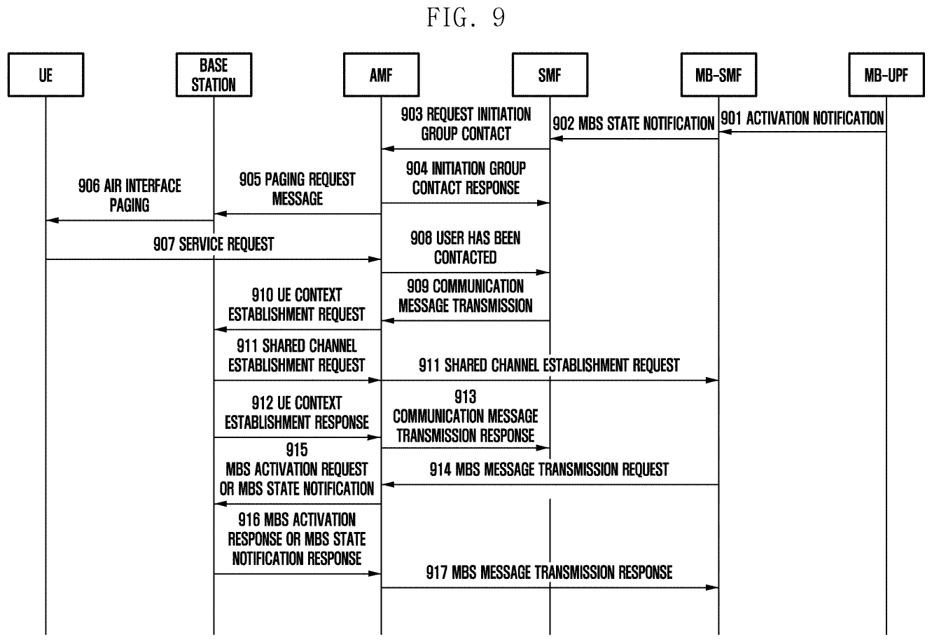

FIG. 9 is a schematic diagram of an activation process according to embodiments of the present disclosure. When the MBS is a multicast service, the multicast service can only be received by users who join the multicast group. The following UE refers to the users who have joined a certain MBS service, and the MBS service is identified by the service identification, TMGI. Within a certain period of time, if the multicast service has no data to transmit, the MBS user plane node (MB-UPF) can decide to initiate the deactivation process, and the MBS service enters the deactivated state.

When the MB-UPF receives the downlink data and knows that this MBS service has downlink data to transmit, the MB-UPF may notify the MBS session management function node (MB-SMF), and then the core network may transmit an activation request message to the NG-RAN base station to activate the user plane that transmits the MBS service. When no data is transmitted for a period of time, the core network transmits a deactivation request message to the NG-RAN base station, and the user plane of the NG-RAN base station and the core network can be released after the deactivation process. This can save the resources of the user plane. The specific activation process is shown in FIG. 9.

At step 901, the MB-UPF receives the downlink data of a certain MBS service, and the MB-UPF transmits a message to the MB-SMF to inform the MB-SMF that the downlink MBS data has reached the MB-UPF. The name of the message can be N4mb notification message or activation notification message, etc. The message contains the session identification (N4 session ID) of the N4 interface, and the message also contains the service identification (TMGI) and other information.

Or the application layer functional entity directly transmits the message of the MBS activation request to the MB-SMF. The message carries the service identification, TMGI, of the MBS.

At step 902, the MB-SMF transmits a message to the session management function entity SMF of the UE.

The message name of this step may be an MBS state notification message, an MBS context state notification message, etc., for example, the Nmbsmf_MB S Session_ContextStatusNotify message, which carries the subscription association information. Herein, the subscription association information at least includes the MBS service identification TMGI and/or the activation indication, which can be set to be activated or deactivated.

The SMF stores the context of the UE and the state of the MBS session. According to the received message of step 902, referring to the subscription association information carried by the message, the SMF sets the state of the MBS session as the activated state, and finds all UEs joining the MBS service from the context of the UE. If the SMF finds that at least one user in the UE joining the MBS service has not activated the packet data unit session (PDU session) related to the MBS, the SMF proceeds to the following step 903. If all users have activated the PDU session related to the MBS, the SMF may go to step 905 instead of steps 903 to 907.

At step 903, the SMF transmits a message to the mobility management entity AMF of the UE, requesting to initiate contact with MBS users. The message name can be request initiation group contact, or the message name can be the Namf_MT_EnableGroupReachability Request message, or other names. The message contains list 1 of the UE, associated information. The list 1 of the UE contains the identification 1 of the UE, through which the AMF can find the context information of the UE stored on the AMF. The associated information is used for the AMF to identify and notify the associated SMF to activate the PDU session related to the MBS after the AMF receives the response message from the UE.

After receiving the message, the AMF finds the corresponding context information of each UE for the UE identification 1 in the UE list 1 and performs the following steps 904 and 905.

At step 904, the AMF transmits an initiation group contact response message to the SMF. The message name can be others. When the UE is in the connected mode (called CM-connected mode at the AMF), the AMF transmits the identification of the UE to the SMF. The response message in step 904 contains the identification list 2 of the UE, and the identification list 2 contains the identification of the UE in CM- connected mode. The response message in step 904 can contain all users in CM- connected mode, and for users in CM- connected mode, steps 905 and 906 are not performed.

At step 905, the AMF transmits a paging message to the NG-RAN base station. When this UE is in idle mode (called CM- idle mode at the AMF), the AMF needs to initiate a paging process to enable the UE to enter the connected mode. In order to effectively utilize paging resources and save signaling, the AMF transmits a group paging message to all users in the CM-idle mode. The AMF decides a suitable paging area according to all UE in the CM-idle mode. The AMF transmits a group paging request message to the NG-RAN base station. The group paging message includes the service identification TMGI, the identification list 2 of the UE, the paging scope and other information. The identification list 2 of the UE contains the UE identification 2, which may be different from the type of UE identification 1 included in the identification list 1 of the UE. For example, the UE identification 2 may be a temporary identification of the UE used in the 5G network (such as 5G-P-TMSI) or the temporary identification module 924.

At step 1006, the NG-RAN base station transmits a paging request message to the UE. Similarly, the NG-RAN transmits a paging message to all users who need to receive the paging message through the air interface.

At step 907, the UE receives the paging message and transmits a service request message to the AMF. The service request is a non-access stratum message, which is forwarded to the AMF through the NG-RAN base station.

At step 1008, the AMF transmits a message informing that the user has been contacted to the SMF. When the AMF receives the service request message transmitted by the UE, according to the association information received in step 903, the AMF finds the corresponding SMF, and the AMF informs the SMF that the UE has been found and entered to the connected mode (similarly, it is called CM-connected mode at the AMF).

At step 909, the SMF transmits a communication message transmission message to the AMF, such as Namf_Communication_N1N2MessageTransfer message, and the message name can be others. This step is to configure the information of the PDU session related to the MBS for the UE. For users for which the PDU session related to the MBS have been activated before step 902, steps 909 and 910 are not performed.

When the SMF receives the response message transmitted by the AMF, such as the message in step 904 or the message in step 908, the SMF determines that the UE is in the connected state. For such UE, the SMF can configure the information of the PDU related to the MBS, that is, activate the PDU session related to the MBS. The SMF transmits to the AMF a message, such as, Namf Communication N1N2MessageTransfer message, which is aimed at a certain UE. The message contains the message of the N2 SM. The N2 SM message contains the MBS service identification TMGI, the MBS session identification, information of the associated QoS and the corresponding information of the unicast QoS flow and the multicast QoS flow. The corresponding information of the unicast QoS flow and the multicast QoS flow is included for the purpose of supporting the establishment of a separate bearer for each user to transmit MBS service between the core network and the access network. According to the current principle, the AMF does not parse the N2 SM message, but forwards the N2 SM message to the NG-RAN base station.

At step 910, the AMF transmits a message to the NG-RAN base station, for example, the SMF transmits a UE context establishment request message or a modification request message to the NG-RAN base station, and the message carries the N2 SM message received by the AMF at step 909.

At step 911, the NG-RAN base station transmits a shared channel establishment request message to the AMF. If it is necessary to establish a shared channel between the NG-RAN base station and the core network user plane node to transmit the MBS service data, the NG-RAN base station initiates the establishment of the shared channel. The message is transmitted to the AMF, which forwards the message to the MB-SMF.

At step 912, the NG-RAN base station transmits a response message to the AMF to response to the message in step 910. The message may be a UE context establishment response message or a modification response message, and the message includes an N2 SM message, which is transmitted to the SMF via the AMF. According to the current principle, the AMF does not parse the N2 SM message and directly forwards the N2 SM message to the SMF.

At step 913, the AMF transmits a message to the SMF, and forwards the N2 SM message transmitted by the NG-RAN base station to the SMF.

At step 914, the MB-SMF transmits an MBS message transmission request message to the AMF. The MB-SMF finds that the shared channel between the MB-UPF and the NG-RAN base station has been established. The MB-SMF transmits a message to the AMF to inform the AMF that the MBS service is activated. The name of the message can be Namf_MB SCommunication_N2MessageTransfer Request or other messages. The message contains the container of session management (SM), which contains the message transmitted by the MB-SMF to the NG-RAN base station. According to the current principle, the SMF does not parse the container, and the container of the SM carries the identification of the service TMGI and activation indication information.

According to a method of the present disclosure , in the message in step 914, the MB-SMF, outside the SM container, needs to contain the identification of the MBS service and the state indication information of the MBS service. The identification of the MBS service can be TMGI, and the state indication information of the MBS service can be set to one of activated, deactivated and updated. When the MB-SMF updates the quality requirement of the MBS service or service area, it can be set to be updated. After reception, the AMF can save the state information of the service in the context of the UE or in the context of the MBS service. How the AMF uses the state information of the service is described in step 916.

At step 915, the AMF transmits an activation request message or an MBS state notification message to the NG-RAN base station. The message of this step may be an activation request message, which contains TMGI. The activation request message can also contain activation indication information, or the message name indicates to activate MBS. According to the method of the present disclosure in step 914, the MB-SMF includes the identification of the MBS service and the state indication information of the MBS service outside the SM container of step 914 message, so that the AMF can know whether the MBS needs to be activated, deactivated or updated. At this time, the AMF can transmit the corresponding activation request message, deactivation request message, or update MBS request message, or indicate whether the state of the MBS is activated, deactivated, or updated in the message of 915.

Or the message in step 915 is an MBS state notification message, which contains the service identification TMGI of the MBS, but does not contain state information. Because the AMF received the message of step 914, without the method of the present disclosure , the AMF does not parse the SM container at present, and the AMF does not know the information on whether the MB-SMF wants to activate the MBS, deactivate the MBS or update the MBS, so the message of step 915 transmitted by the AMF to the NG-RAN base station only contains the service identification TMGI, but there is no state information such as activated and deactivated.

At step 916, the base station of the NG-RAN transmits an activation response message or an MBS state notification response message to the AMF. Upon receiving the message of step 915, the base station knows that this MBS starts to be activated, and the base station establishes the radio resources of the RAN side and the UE side and establishes the radio channel to transmit the data of the multicast service. The purpose of enabling the base station to know that the MBS service is in the activated state is to enable the base station to keep the UE in the connected mode. For users who have joined the service, the base station cannot release the wireless connection, even if the UE has no other unicast service or the base station has not received any data of the unicast service.

Generally speaking, if the base station does not receive the data of the unicast service within a certain period of time, the base station may release radio bearers of the users, so that the UE can return to the idle mode or the deactivated mode. However, when the UE joins a certain MBS service and the service is in the activated state, the base station keeps the UE in RRC connected state.

If the message in step 915 does not contain the MBS state information, or the state of MBS cannot be known from the message name, it means that the AMF does not know the state of the MBS. The response message transmitted by the base station to the AMF may carry the MBS service identification TMGI and the state information of this service, and the state information can be set to be activated, deactivated or updated. Or the base station transmits a separate message, which carries the identification and state information of the MBS to inform the AMF of the state of the MB S. The AMF gets the identification of the MB S service and the state information of the service, and the AMF saves the state information in the context of the MBS and can also save the state information in the context of the UE.

When the AMF knows the state of the MBS service, which can be one of activated, deactivated and updated, the AMF refers to the state of the MB S, for example, whether the state of the MBS is activated or deactivated, and determines the state of UE. At present, for a certain UE, if the AMF receives the message of releasing the session transmitted by the PDU session control node SMF, where the PDU session refers to the traditional unicast packet data unit session, the AMF may transmit a message to the base station to release the resources of the PDU session. If the UE has multiple PDU sessions, and the AMF receives the release requests of all PDU sessions, that is, all unicast PDU sessions need to be released, the AMF may transmit the UE context release request to the base station to release all the wireless resources and enable the UE to enter the idle mode.

According to the method of the present disclosure , if the AMF saves the MBS service that the UE joined and the state of the MBS service, the AMF may refer to the state of the MBS service to decide whether to enable the UE to enter the idle mode. For example, a certain MBS service that UE has joined is in the activated state, although all unicast PDU sessions of the UE have been released, the AMF still keeps the UE in the connected mode (that is, CM- connected mode) and does not transmit the UE context release request message to the base station. If the joined MBS service is in the deactivated state, the AMF can enable the UE to enter the idle mode and transmit the UE context release request message to the base station, and the base station releases the radio resources to enable the UE to enter the idle mode.

According to the method of the present disclosure , the AMF can keep the UE in the connected mode during the activation of the MBS multicast service, so that the UE can normally receive the MBS service; otherwise, the AMF may initiate the connection release process, but the current connection release process cannot be rejected by the base station of the NG-RAN. Without the method of the present disclosure , the base station of the NG-RAN cannot keep the UE receiving the multicast service in the connected mode, resulting in that the UE cannot normally receive the MBS service and the service data reception is interrupted.

At step 917, the AMF transmits a message to the MB-SMF, which is the response message of 914. The message may be Namf_MB SCommunication_N2MessageTransfer Response, which confirms that the message of step 1014 has been transmitted, and the message at least carries the identification of the MBS service.

The method shown in FIG. 9 is also used in the MBS deactivation and update process. According to one method of the present disclosure , the MB-SMF transmits an MBS message transmission request message to the AMF, such as Namf_MBSCommunication_N2MessageTransfer Request request message. Outside the SM container, the MB-SMF needs to contain the identification of the MBS service and the state indication information of the MBS service. The identification of the MBS service can be TMGI, and the state indication information of the MBS service can be set to be deactivated or updated, respectively. When the state of the MBS received by the AMF is deactivated, it can decide whether to enable the UE to enter the CM- idle mode according to the current process. When the state of the MBS received by the AMF is updated, the AMF still needs to keep the UE in the CM-connected mode, as shown in step 906.

According to another method of the present disclosure , when the base station of the NG-RAN receives the message of the MBS state notification, the base station knows the state of the MBS service through the SM container contained in the message. The response message transmitted by the base station to the AMF may carry the MBS service identification TMGI and the state information of the service, which can be set to be activated, deactivated or updated. Or the base station transmits a separate message, which carries the identification and state information of the MBS to inform the AMF of the state of the MBS. The SMF gets the identification of the MB S service and the state information of the service, and the AMF saves the state information in the context of the MBS and can also save the state information in the context of the UE. When the state of the MBS received by the AMF is deactivated, it can decide whether to enable the UE to enter the CM- idle mode according to the current process. When the state of the MBS received by the AMF is updated, the SMF still needs to keep the UE in the CM-connected mode, as shown in step 906.

Those of ordinary skill in the art will recognize that the description of the multicast and broadcast service (MBS) transmission method and device is illustrative only and is not intended to be limiting in any way. Other embodiments will readily occur to those of ordinary skill in the art having the benefit of this disclosure. Any modification, equivalent substitution, improvement, etc., made within the spirit and principle of this disclosure shall be included in the scope of protection of this disclosure.

What is claimed is:

1. A method for notifying a multicast and broadcast service (MBS) state, the method comprising:
receiving, by a mobile management entity (AMF), state information of MBS; and
determining, by the AMF, whether to enable a user equipment (UE) to enter an idle mode based on the state information.

2. The method according to claim 1, wherein the state information of the MBS is received from an MBS session management entity (MB-SMF).

3. The method according to claim 1, wherein the state information of the MBS is obtained from a base station of a next generation radio access network (NG-RAN).

4. The method according to claim 1, wherein the state information of the MBS includes one of an activated state, a deactivated state, or an updated state.

5. The method according to claim 1, in case that the state information of the MBS is activated or updated, the AMF keeps the UE in a connected mode.

6. The method according to claim 2, a service identification of the MBS and the state information of the MBS is included by the MB-SMF outside a session container.

7. A method for notifying a multicast and broadcast service (MBS) state, the method comprising:
acquiring, by a network entity, state information of MBS; and
transmitting, by the network entity, the state information of the MBS to a mobility and management entity (AMF),
wherein whether to enable a user equipment (UE) to enter an idle mode is determined based on the state information.

8. The method according to claim 7, wherein the network entity comprises an MBS session management entity (MB-SMF) or a base station of a next generation radio access network (NG-RAN).

9. The method according to claim 7, wherein the state information of the MBS includes one of an activated state, a deactivated state, or an updated state.

10. The method according to claim 7, in case that the state information of the MBS is activated or updated, the UE is kept by the AMF in a connected mode.

11. The method according to claim 8, in case that the network entity comprises the MB-SMF, the MB-SMF includes a service identification of the MBS and the state information of the MBS outside a session container.

12. A core network device for notifying a multicast and broadcast (MBS) state, the core network device comprising:
a transceiver;
memory; and
a processor operably connected to the transceiver and the memory, the processor configured to:
receive state information of MBS, and
determine whether to enable a user equipment (UE) to enter an idle mode according to the state information.

13. The core network device according to claim 12, wherein the state information of the MBS is received from an MBS session management entity (MB-SMF).

14. The core network device according to claim 12, wherein the state information of the MBS is obtained from a base station of a next generation radio access network (NG-RAN).

15. The core network device according to claim 12, wherein the state information of the MBS includes one of an activated state, a deactivated state, or an updated state.

16. The core network device according to claim 12, in case that the state information of the MBS is activated or updated, a mobile management entity (AMF) keeps the UE in a connected mode.

17. The core network device according to claim 13, a service identification of the MBS and the state information of the MBS is included by the MB-SMF outside a session container.

18. A network device for notifying a multicast and broadcast (MB S) state, the network device comprising:
a transceiver;
memory; and
a processor operably connected to the transceiver and the memory, the processor configured to:
acquire state information of MBS; and
transmit the state information of the MBS to a mobility and management entity (AMF),
wherein whether to enable a user equipment (UE) to enter an idle mode is determined based on the state information.

19. The network device according to claim 18, wherein:
a network entity comprises an MBS session management entity (MB-SMF) or a base station of a next generation radio access network (NG-RAN); and
the state information of the MBS includes one of an activated state, a deactivated state, or an updated state.

20. The network device according to claim 19, wherein:
in case that the state information of the MBS is activated or updated, the UE is kept by the AMF in a connected mode; and
in case that the network entity comprises the MB-SMF, the MB-SMF includes a service identification of the MBS and the state information of the MBS outside a session container.
